(19) United States
(12) Patent Application Publication
(10) Pub. No.: US 2018/0328211 A1
(43) Pub. Date: Nov. 15, 2018

(54) Dry Gas Seal And Turbomachine Having A Dry Gas Seal

(71) Applicant: MAN DIESEL & TURBO SE, Augsburg (DE)

(72) Inventors: Roger SUTER, Zürich (CH); Michael BETSCHART, Vitznau (CH)

(73) Assignee: MAN DIESEL & TURBO SE, Augsburg (DE)

(21) Appl. No.: 15/770,013

(22) PCT Filed: Oct. 20, 2016
(86) PCT No.: PCT/EP2016/075295

§ 371 Date: Apr. 20, 2018

(30) Foreign Application Priority Data
Oct. 22, 2015 (DE) 10 2015 013 660.7

(51) Int. Cl. F01D 11/04; F16J 15/34; F04D 29/12; F16J 15/36

(52) U.S. Cl. CPC F01D 11/04; F16J 15/3464; F05D 2300/501; F16J 15/36; F05D 2250/61; F04D 29/122

(57) ABSTRACT

A dry gas seal of a turbomachine, more particularly of a turbocompressor, for sealing a rotor-side component of the turbomachine with respect to a stator-side component of the turbomachine, having a sealing device and a support device for a stator-side sealing element of the sealing device, which can be elastically deformed.

### CROSS REFERENCE TO RELATED APPLICATIONS

This is a U.S. national stage of application No. PCT/EP2016/075295, filed on Oct. 20, 2016. Priority is claimed on German Application No. DE102015013660.7, filed Oct. 22, 2015, the content of which is incorporated here by reference.

### BACKGROUND OF THE INVENTION

### 1. Field of the Invention

The invention relates to a dry gas seal for a turbomachine and to a turbomachine with such a dry gas seal.

### 2. Description of the Prior Art

In turbomachines, such as for example in turbocompressors, dry gas seals are increasingly employed as seals, which replace traditionally oil film seals.

FIG. 1 shows the construction of a conventional dry gas seal of a turbomachine known from the prior art. Accordingly, FIG. 1 shows a dry gas seal 1 that seals a rotor-side component 2 of the turbomachine relative to a stator-side component 3 of the turbomachine. The dry gas seal 1 comprises a sealing device 4 and a support device 5. The sealing device 4 comprises a rotor-side sealing element 6 and a stator-side sealing element 7. The rotor-side sealing side element 6 is fastened to the rotor-side component 2 and the stator-side sealing element 7 is fastened to the stator side support device 5.

The support device 5 can be moved in the axial direction of the rotor-side component 2 relative to the stator-side component 3, namely via a spring 8, which supports itself between the stator-side component 3 and the stator-side support device 5 and via a defined sliding fit between the support device 5 and the stator-side component 3. The spring element 8 pushes the stator-side sealing element 5 against the rotor-side sealing element 6 of the sealing device 4 thus providing a good sealing effect.

Between the stator-side sealing element 7 and the stator-side support device 5 as well as between the stator-side support device 5 and the stator-side support device 5 and the stator-side component 3, sealing devices typically formed as O-rings can be received in grooves 9 of the support device 5.

### SUMMARY OF THE INVENTION

Although with the dry gas seal 1 known from the prior art shown in FIG. 1 a good sealing of the rotor 2 relative to the stator 3 can already be ensured, there is a need for simplifying the construction of the dry gas seal 1. In particular, it is sought to omit the sliding fit between the stator-side support device 5 and the stator-side component 3. Sliding fits are expensive to produce and are subject to a contamination risk during the operation of the turbomachine by way of deposits of condensates and coking-up, as a result of which the dry gas seals can then fail.

Starting out from this, one aspect of the present invention is based on providing a more reliable gas seal with a simpler construction and a turbomachine with such a dry gas seal.

According to one aspect of the invention, the support device is elastically deformable. The invention, the support device of the dry gas is designed so that it is elastically deformable. As a result, the separate spring element required according to the prior art and a sliding fit between the stator-side support device and the stator-side component can be omitted.

According to an advantageous further development, the support device is elastically deformable in the axial direction of the rotor-side component. By way of this a good sealing effect with a simpler construction of the dry gas seal can be ensured in a particularly simple manner.

According to an advantageous further development, the support device is designed bellows-like, preferentially as a one-piece bellows. The bellows-like structure of the support device is simple in terms of construction and allows a good sealing effect of the dry gas seal.

According to an advantageous further development, the support device is non-rotationally fastened with a first section to the stator-side component, wherein the support device on a second section located opposite carries the stator-side sealing element of the sealing device that interacts with a rotor-side sealing element of the sealing device. This is preferred for ensuring a simple construction of the dry gas seal.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a schematic axial section through a turbomachine in the region of a dry gas seal according to the prior art; and

FIG. 2: is a schematic axial section through a turbomachine in the region of a dry gas seal according to the invention.

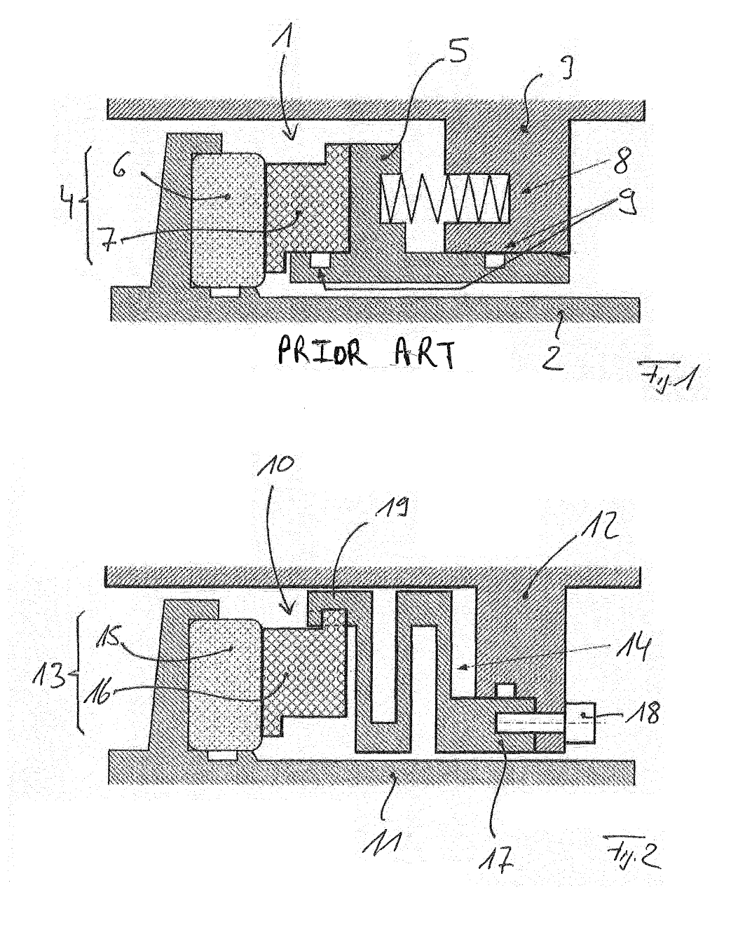

### DETAILED DESCRIPTION OF THE PRESENTLY PREFERRED EMBODIMENTS

FIG. 2 shows a dry gas seal 10 of a turbomachine or a turbocompressor according to the invention.

The dry gas seal 10 serves for sealing a rotor-side component, called rotor 11, of the turbomachine relative to a stator-side component, called stator 12.

The dry gas seal 10 according to one aspect of the invention again comprises a sealing device 13 and a support device 14 for the sealing device 13, namely for a stator-side sealing element 16 of the sealing device 13. This stator-side sealing element 16 of the sealing device 13 interacts with the rotor-side sealing element 15 of the same.

According to one aspect of the invention, the support device 14 is elastically deformable, namely in the axial direction of the rotor 11. Because of this, the spring element on the one hand, which is required according to the prior art and on the other hand a sliding fit between the support device 14 and the stator 12 can be omitted.

In the shown preferred exemplary embodiment of FIG. 2, the support device 14 is embodied bellows-like, namely formed by a one-piece bellows. By way of the specific geometrical embodiment of the bellows an elastic deformation characteristic in the axial direction can be defined.

The support device 14 is non-rotationally fastened to the stator 12 with a first section 17, namely with a fastening device 18. On a second section 19 of the support device 14 located opposite the first section 17, the support device 14 carries the stator-side sealing element 16 of the sealing device 13. Between the first section 17 and the second section 19 the support device 14 is formed bellows-like.

In the radial direction of the rotor 11, the support device 14 assumes a guiding function for providing a defined radial relative position between the sealing elements 15, 16.

With the invention, a simple and reliable construction of a dry gas seal can be ensured. In particular, a susceptible and expensive sliding fit between the support device 14 for the stator-side sealing element 16 and the stator or housing 12 can be omitted. Furthermore, a separate spring element that supports itself on the stator and the support device can be omitted.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A dry gas seal of a turbomachine, configured to seal a rotor-side component of the turbomachine relative to a stator-side component of the turbomachine, comprising:
a sealing device;
a stator-side sealing element of the sealing device; and
an elastically deformable support device for the stator-side sealing element.

10. The dry gas seal according to claim 9, wherein the elastically deformable support device is bellows-like.

11. The dry gas seal according to claim 10, wherein the elastically deformable support device is a one-piece bellows.

12. The dry gas seal according to claim 9, wherein the elastically deformable support device is elastically deformable in an axial direction of the rotor-side component.

13. The dry gas seal according to claim 9,
wherein the elastically deformable support device is non-rotationally fastened to the stator-side component by a first section, and
wherein the elastically deformable support device carries the stator-side sealing element of the sealing device by a second section located opposite the first section,
wherein the stator-side sealing element interacts with a rotor-side sealing element of the sealing device.

14. The dry gas seal according to claim 13, wherein the elastically deformable support device between the first section and the second section is bellows-like.

15. The dry gas seal according to claim 13, wherein the elastically deformable support device pushes the stator-side sealing element of the sealing device against the rotor-side sealing element of the sealing device.

16. A turbomachine configured as a turbocompressor, comprising:
a stator;
a rotor mounted in the stator; and
a dry gas seal for sealing the rotor relative to the stator, comprising:
a sealing device;
a stator-side sealing element of the sealing device; and
an elastically deformable support device for the stator-side sealing element.

17. The dry gas seal according to claim 9, wherein the turbomachine is a turbocompressor.

18. The dry gas seal according to claim 11, wherein the elastically deformable support device is elastically deformable in an axial direction of the rotor-side component.

19. The dry gas seal according to claim 18,
wherein the elastically deformable support device is non-rotationally fastened to the stator-side component by a first section, and
wherein the elastically deformable support device carries the stator-side sealing element of the sealing device by a second section located opposite the first section,
wherein the stator-side sealing element interacts with a rotor-side sealing element of the sealing device.

20. The dry gas seal according to claim 14, wherein the elastically deformable support device pushes the stator-side sealing element of the sealing device against the rotor-side sealing element of the sealing device.
